(19) United States
(12) Patent Application Publication
(10) Pub. No.: US 2026/0054916 A1
(43) Pub. Date: Feb. 26, 2026

(54) BEVERAGE PREPARATION SYSTEM FOR PREPARING A BEVERAGE USING A SINGLE-SERVE CAPSULE, AND USE OF SINGLE-SERVE CAPSULES FOR PREPARING A BEVERAGE

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 19/105,571

(22) PCT Filed: Aug. 17, 2023
(86) PCT No.: PCT/EP2023/072667

§ 371 Date: Feb. 21, 2025

(30) Foreign Application Priority Data
Aug. 24, 2022 (DE) 10 2022 208 773.9

(51) Int. Cl. B65D 85/804; A47J 31/36; A47J 31/40

(52) U.S. Cl. CPC B65D 85/8061; A47J 31/36; A47J 31/407

(57) ABSTRACT

Proposed is a beverage preparation system for preparing a beverage using a single-serve capsule, the system comprising a beverage preparation machine and a single-serve capsule, the beverage preparation machine having a brewing chamber for receiving the single-serve capsule, the single-serve capsule having a base element which defines a cavity, the cavity being partially filled with a beverage raw material, and the single-serve capsule having an insert which is disposed in the cavity and at least partially prevents the beverage raw material from sliding out of position in the cavity, wherein the beverage preparation system comprises at least one first single-serve capsule and at least one second single-serve capsule, wherein the first single-serve capsule has a first insert, and wherein the second single-serve capsule has a second insert, wherein the first insert is designed dissimilarly to the second insert.

### PRIOR ART

The present invention proceeds from a beverage preparation system for preparing a beverage using a single-serve capsule, the system comprising a beverage preparation machine and a single-serve capsule, the beverage preparation machine having a brewing chamber for receiving the single-serve capsule, the single-serve capsule having a base element which defines a cavity, the cavity being partially filled with a beverage raw material, and the single-serve capsule having an insert which is disposed in the cavity and at least partially prevents the beverage raw material from sliding out of position in the cavity.

Beverage preparation systems of this type are well known in the prior art. The single-serve capsule is usually provided to be inserted directly or indirectly into the brewing chamber, wherein the single-serve capsule is perforated in the brewing chamber in order to direct pressurized liquid in the form of hot water into the cavity. Created as a result of the interaction between the inducted water and the beverage raw material, in particular roasted and ground coffee, is a beverage which leaves the single-serve capsule through additional perforated locations and makes its way into a container.

Vertically aligned as well as horizontally aligned brewing chambers are known. In the case of horizontal brewing chambers in particular, the single-serve capsule is mounted horizontally, thus on its side. It may arise in the process that the beverage raw material slides out of position, which may lead to incomplete extraction. Moreover, the beverage raw material can also make its way close to the covering film that closes the single-serve capsule, as a result of which the injected liquid cannot be distributed adequately over the entire area of the beverage raw material, which may likewise cause insufficient extraction.

Therefore, it is already known to dispose a water distributor in the single-serve capsule, which offers the inflowing liquid a space in which the liquid can be distributed so as to subsequently make its way through openings of the water distributor, in a fashion similar to that of a showerhead, over a wide area to the beverage raw material. In some instances, water distributors of this type are also used to compress the beverage raw material. Both rigid water distributors, similar to the insert according to the invention, as well as flexible water distributors which are embodied for example as a film that is sealed to the capsule wall in an encircling manner are known.

Finally, it is furthermore known that different beverages, in particular also different coffee beverages, can be prepared by means of a single-serve capsule. For example, an espresso or a lungo may be prepared, these typically differing from one another mainly in terms of the volume of liquid used. However, a multiplicity of mutually interacting parameters are relevant when preparing coffee, including inter alia the pressure of the liquid, the temperature, the liquid volume, the grinding coarseness of the coffee powder, the quantity of coffee powder, the degree of compression, to mention only a few.

Since the brewing chamber and the single-serve capsule are mutually adapted, inter alia in order to withstand the high pressures acting during the preparation of the beverage, this however leads to the issue that the volume of the single-serve capsule to be filled with the beverage raw material is fixedly established. Thus, it is possible to operate with a constant volume of beverage raw material and a variable liquid volume, or the volume of beverage raw material is varied, this however resulting in the issues mentioned above in terms of insufficient extraction.

For this reason, novel beverage preparation systems which operate using single-serve capsules of different sizes and, associated therewith, different internal volumes have recently been proposed. However, the known single-serve capsules cannot be used in these beverage preparation systems, and the user has to procure a new beverage preparation machine as well as new single-serve capsules.

### DISCLOSURE OF THE INVENTION

It is therefore an object of the present invention to make available a beverage preparation system which can prepare different types of beverages, in particular different types of coffee beverages, of high quality, in particular using already known beverage preparation machines.

The object of the present invention is achieved by a beverage preparation system for preparing a beverage using a single-serve capsule, the system comprising a beverage preparation machine and a single-serve capsule, the beverage preparation machine having a brewing chamber for receiving the single-serve capsule, the single-serve capsule having a base element which defines a cavity, the cavity being partially filled with a beverage raw material, and the single-serve capsule having an insert which is disposed in the cavity and at least partially prevents the beverage raw material from sliding out of position in the cavity, wherein the beverage preparation system comprises at least one first single-serve capsule and at least one second single-serve capsule, the first single-serve capsule having a first insert, and the second single-serve capsule having a second insert, the first insert being designed dissimilarly to the second insert.

Advantageous design embodiments and refinements of the invention can be derived from the dependent claims and from the description hereunder with reference to the drawings.

The advantages and associated embodiments explained in the context of this subject matter of the present invention apply in an analogous manner also to the other subject matter of the present invention, and vice versa.

The beverage preparation system according to the invention is particularly advantageous because different types of single-serve capsules, which can be used for preparing different types of beverages, are provided by a different design of an insert.

A single-serve capsule in the context of the present invention has a base element which defines a cavity. Preferably, the single-serve capsule has on one end an opening which is closed off in a gas-tight and/or aroma-tight manner by a cover, in particular a covering film. The cavity is partially filled with a beverage raw material, meaning in particular that at least part of the volume of the cavity is not filled with the beverage raw material. The base element is preferably formed so as to be substantially rotationally symmetrical about a rotation axis extending centrically through the single-serve capsule. The beverage raw material comprises, for example, roasted coffee granules, instant coffee, chocolate powder, a tea blend, milk powder and/or a liquid, a syrup, a solid material, a powder, coffee or cocoa grounds, and/or tea leaves. The single-serve capsule can contain one or a plurality of beverage raw materials.

According to a preferred embodiment of the present invention, it is provided that the base element is made of plastics material. The base element is preferably produced by hot or cold forming, in particular deep-drawing. The design embodiment of the base element with a cavity is preferably generated by thermoforming, for example deep-drawing by vacuum-forming, or pressurized forming and/or by a movable die. Alternatively, the single-serve capsule is produced by means of injection-molding methods, in particular by a single-component method, a multi-component method or by an in-mold method. The base element is preferably formed from polyethylene (PE), polypropylene (PP), polyvinylchloride (PVC), polymethyl methacrylate (PMMA), polycarbonate (PC), polystyrene (PS), polyphenylene ether (PPO), or polyethylene terephthalate (PET).

The cover, in particular the covering film, is preferably formed from polyethylene (PE), polypropylene (PP), polyvinylchloride (PVC), polymethyl methacrylate (PMMA), polycarbonate (PC), polystyrene (PS), polyphenylene ether (PPO), or polyethylene terephthalate (PET). Particularly preferably, the cover, in particular the covering film, is provided in multiple layers, wherein at least one layer most particularly preferably comprises an aluminum material. The cover preferably comprises a plastic/aluminum composite film, or a plastic film, or a multi-layer plastic film. It is conceivable that the covering film and the base element are at least partially made of the same material.

The base element is preferably designed to be frustoconical, conical, cylindrical, spherical, hemispherical, elliptic or semi-elliptic. The base element is preferably designed to be rigid or semi-rigid.

Furthermore, the single-serve capsule now has an insert which is disposed in the cavity and at least partially prevents the beverage raw material from sliding out of position in the cavity. The insert is preferably an at least partially rigid insert. Particularly preferably, the insert is connected to the base element in a form-fitting, force-fitting and/or materially integral manner. The insert preferably comprises an encircling lateral wall and a base region, wherein the insert separates an in particular upper part of the cavity from an additional, in particular lower, part of the cavity, wherein the beverage raw material is disposed in the additional cavity. The base region preferably has a multiplicity of openings through which the liquid can enter the beverage raw material, wherein the openings are particularly preferably sized in such a manner that the liquid, but not the beverage raw material, can pass through. Particularly preferably, the base region of the insert is provided to be substantially flat, i.e., in particular, the base region is provided so as to be parallel to a plane defined by the opening of the single-serve capsule. Most particularly preferably, the openings of the base region are homogeneously distributed. In particular, the base region is designed in the manner of a sieve. The insert preferably has an outwardly extending, encircling protrusion, wherein the protrusion is in particular provided so as to be in the manner of a lip by way of which the insert is connected to the wall of the base element in a form-fitting and/or force-fitting manner, in particular clamped. The insert is most particularly preferably disposed so as to be stationary in the base element. This means in particular that the relative position of the insert in relation to the base element does not substantially change even under the influence of the beverage raw material, the liquid and/or the beverage.

The base element preferably has a stacking shoulder close to the opening, i.e. a protrusion which is provided in such a manner that when a plurality of empty base elements are stacked in one another, the base regions of the base elements are spaced apart from one another in such a way that the base elements are easy to separate from one another. Furthermore, the base element can have on its outside a multiplicity of concentrically disposed and encircling grooves and/or protrusions. The base element preferably has a flange-type periphery which surrounds the opening and particularly preferably extends radially outward in a plane with the opening. The cover, in particular the covering film, is particularly preferably fastened, in particular sealed, to the periphery.

It is now provided according to the invention that the beverage preparation system comprises at least one first single-serve capsule and at least one second single-serve capsule, wherein the first single-serve capsule has a first insert, and wherein the second single-serve capsule has a second insert, wherein the first insert is designed dissimilarly to the second insert. As a result, it is enabled in a particularly advantageous way that different beverages of high quality can be prepared solely by selecting a suitable insert. The person skilled in the art will understand that the first single-serve capsule corresponds in particular to a first type of single-serve capsule, and the second single-serve capsule corresponds in particular to a second type of single-serve capsule. The beverage preparation system preferably comprises additional types of single-serve capsules, for example a third single-serve capsule and/or a fourth single-serve capsule, each comprising a third or fourth insert, respectively, wherein the third insert is dissimilar to the first, the second and the fourth insert, and/or the fourth insert is dissimilar to the first, the second and the third insert. The first insert and/or the second insert are/is preferably designed to be rotationally symmetrical in terms of the longitudinal axis of the single-serve capsule. The first insert and the second insert are preferably connected to the base element at the same location. An upper edge of the first insert is particularly preferably disposed at the same height relative to the base element as an upper edge of the second insert.

According to a preferred embodiment it is provided that the second insert has a greater extent along the longitudinal axis of the single-serve capsule, which corresponds in particular to a rotational symmetry axis, than the first insert. As a result, it is advantageously possible to vary the volume available to the beverage raw material while not varying other dimensions of the base element as well as of the insert, presently in particular an identical diameter.

According to a preferred embodiment it is provided that the first insert extends over 20 to 40 percent, preferably 25 to 35 percent, particularly preferably by 27.5 to 32.5 percent, of the overall extent of the single-serve capsule along the longitudinal axis. As a result thereof, the volume available to the beverage raw material is advantageously also indirectly defined.

According to a preferred embodiment it is provided that the first insert has an extent along the longitudinal axis of 4 to 10 mm, preferably 6 to 8 mm, particularly preferably 6.5 to 7.5 mm. The inventors have found that an extent of this type of the first insert is particularly advantageous for preparing a lungo coffee beverage.

According to a preferred embodiment it is provided that the second insert extends along the longitudinal axis over 40 to 65 percent, preferably 45 to 60 percent, particularly preferably by 50 to 55 percent, of the overall extent of the single-serve capsule along the longitudinal axis. As a result, the volume available to the beverage raw material is advantageously also indirectly defined.

According to a preferred embodiment it is provided that the second insert has an extent along the longitudinal axis of 8 to 18 mm, preferably 12 to 14 mm, particularly preferably 12.5 to 13.5 mm. The inventors have found that an extent of this type of the second insert is particularly advantageous for preparing an espresso.

According to a preferred embodiment it is provided that the first insert has a smaller effective volume than the second type of insert. An effective volume is presently understood to mean in particular the free part of the internal volume of the cavity that is disposed on the side of the insert facing away from the beverage raw material. This effective volume herein is preferably the volume which is available to the liquid incorporated into the single-serve capsule, thus corresponding in particular to an accumulated liquid volume. In particular when the base element of the first single-serve capsule is preferably designed to be identical to the base element of the second single-serve capsule, the volume of the first single-serve capsule into which the beverage raw material is able to be filled is thus in particular larger than the corresponding volume of the second single-serve capsule. It is however pointed out that this does not necessarily mean a correspondingly smaller or larger volume of the beverage raw material. On the one hand, it is possible that the entire volume available to the beverage raw material is not filled with beverage raw material; on the other hand, the first single-serve capsule and/or the second single-serve capsule can comprise additional elements which reduce the available volume, example filter elements or the like. Preferably however, the first single-serve capsule and/or the second single-serve capsule do not comprise any additional elements or identical additional elements, in particular at least one identical filter element in the base region.

According to a preferred embodiment it is provided that the first insert effectively occupies 25 to 45 percent, preferably 30 to 42 percent, and particularly preferably 34 to 38 percent, of the internal volume of the cavity. As a result, the volume of the single-serve capsule that is utilizable in particular for the liquid, the beverage raw material and/or the beverage is advantageously adjustable by way of the first insert.

According to a preferred embodiment it is provided that the second insert effectively occupies 50 to 65 percent, preferably 55 to 60 percent, and particularly preferably 57 to 58 percent, of the internal volume of the cavity. As a result, the volume of the single-serve capsule that is utilizable in particular for the liquid, the beverage raw material and/or the beverage is advantageously adjustable by way of the first insert.

According to a preferred embodiment it is provided that the first single-serve capsule has a first quantity of beverage raw material, and wherein the second single-serve capsule has a second quantity of beverage raw material, wherein the first quantity is dissimilar to the second quantity. As a result, it is particularly advantageously possible to prepare different beverages, in particular using base elements having substantially identical external dimensions.

According to a preferred embodiment it is provided that the first quantity is larger than the second quantity. As a result, it is possible, for example, that the first single-serve capsule is able to be used for producing a beverage with a larger volume than the second single-serve capsule. For example, the first single-serve capsule is provided for producing a lungo, while the second single-serve capsule is designed for producing an espresso.

According to a preferred embodiment it is provided that the first quantity comprises 5.5 to 9.5 g, preferably 6.5 to 8.5 g, particularly preferably 7 to 8 g. The inventors have surprisingly found that this quantity of beverage raw material is optimal in particular for producing a high-quality lungo.

According to a preferred embodiment it is provided that the first quantity effectively occupies 55 to 75 percent, preferably 58 to 70 percent, and particularly preferably 62 to 66 percent, of the internal volume of the cavity. Advantageously, the available internal volume of the cavity is thus optimally utilized. In the process, the first quantity preferably does not fill the entire volume provided by the first insert. Particularly preferably, a predetermined empty volume remains in the part of the cavity delimited by the first insert. Most particularly preferably, the empty volume is less than 20%, even more preferably less than 10%, and in particular less than 5% of the effectively available volume.

According to a preferred embodiment it is provided that the second quantity comprises 4 to 8 g, preferably 5 to 7 g, particularly preferably 5.5 to 6.5 g. The inventors have surprisingly found that this quantity of beverage raw material is particularly optimal for producing a high-quality espresso.

According to a preferred embodiment it is provided that the second quantity effectively occupies 45 to 50 percent, preferably 40 to 45 percent, and particularly preferably 42 to 43 percent of the internal volume of the cavity. Advantageously, the available internal volume of the cavity is thus optimally utilized. In the process, the first quantity preferably does not fill the entire volume provided by the first insert. Particularly preferably, a predetermined empty volume remains in the part of the cavity delimited by the first insert. Most particularly preferably, the empty volume is less than 20%, even more preferably less than 10%, and in particular less than 5% of the effectively available volume.

According to a preferred embodiment it is provided that the overall extent along the longitudinal axis, the external volume and/or the external shape of the first single-serve capsule is identical to the second single-serve capsule, wherein the overall extent is in particular between 20 and 32, preferably between 25 and 28, particularly preferably between 26 and 27 mm. The external dimensions of the base element of the first single-serve capsule are preferably substantially identical to the external dimensions of the base element of the second single-serve capsule. This is most particularly advantageous because the first and the second single-serve capsule thus can be safely used in the same brewing chamber and/or the same beverage preparation machine, because the brewing chamber is adapted optimally to the first single-serve capsule and to the second single-serve capsule without any modifications.

According to a preferred embodiment it is provided that the internal volume of the cavity is between 20 and 27 ml, preferably between 22 and 25 ml, particularly preferably between 23 and 24 ml, and most particularly preferably is substantially 23.5 ml. This internal volume is particularly advantageously optimal in order on the one hand to provide the inflowing liquid with sufficient space for accumulation in the context of an injection chamber, and on the other hand to provide sufficient space, i.e. volume, for different quantities of beverage raw material so that a multiplicity of different beverages can be optimally prepared.

According to a preferred embodiment it is provided that the effective volume of the first insert is between 6 and 10 ml, preferably between 7 and 9 ml, and particularly preferably is substantially 8 ml. This effective volume is preferably the part of the internal volume of the cavity that is not accessible to the beverage raw material, and/or the part of the internal volume that is available to the liquid after the latter has been incorporated into the single-serve capsule and before passing through the first insert.

According to a preferred embodiment it is provided that the volume of the first quantity is between 13.5 and 17.5 ml, preferably between 14.5 and 15.5 ml, and particularly preferably is substantially 15.5 ml. The inventors have surprisingly found that this volume of beverage raw material is optimal in particular for producing a high-quality lungo.

According to a preferred embodiment it is provided that the effective volume of the second insert is between 8 and 13 ml, preferably between 10 and 11 ml, and particularly preferably is substantially 10.5 ml. This effective volume is preferably the part of the internal volume of the cavity that is not accessible to the beverage raw material, and/or the part of the internal volume that is available to the liquid after the latter has been incorporated into the single-serve capsule and before passing through the first insert.

According to a preferred embodiment it is provided that the volume of the second quantity is between 10.5 and 15.5 ml, preferably between 12.5 and 13.5 ml, and particularly preferably is substantially 13 ml. The inventors have surprisingly found that this volume of beverage raw material is particularly optimal for producing a high-quality espresso.

The person skilled in the art will understand that the sizes quantity, thus in particular mass, and volume may correspondingly be equivalent under standard conditions, but do not always have to be identical. This is in particular also a function of the degree of compression of the coffee powder.

A further subject matter of the present invention is the use of a first single-serve capsule and/or a second single-serve capsule for preparing a beverage in a beverage preparation system according to the present invention.

Advantageous design embodiments and refinements of the invention can be derived from the dependent claims and from the description hereunder with reference to the drawings.

The advantages and the associated embodiments explained in the context of this subject matter of the present invention also apply in an analogous manner to the other subject matter of the present invention, and vice versa. Further details, features and advantages of the beverage preparation system and/or of the use are derived from the drawings and from the description hereunder of preferred embodiments by means of the drawings. The drawings here illustrate only exemplary embodiments of the single-serve capsules, which do not limit the substantial concept of the invention.

### BRIEF DESCRIPTION OF THE DRAWINGS

FIGS. 1a and 1b show a perspective view of a base element of a single-serve capsule according to an exemplary embodiment of the present invention.

FIG. 2 shows a lateral cross section of a single-serve capsule according to the exemplary embodiment of the present invention.

FIGS. 3a and 3b show schematic cross sections of a first insert and of a second insert according to an exemplary embodiment of the present invention.

FIG. 4a shows a schematic cross section of a first single-serve capsule according to an exemplary embodiment of the present invention.

FIG. 4b shows a schematic cross section of a second single-serve capsule according to an exemplary embodiment of the present invention.

### EMBODIMENTS OF THE INVENTION

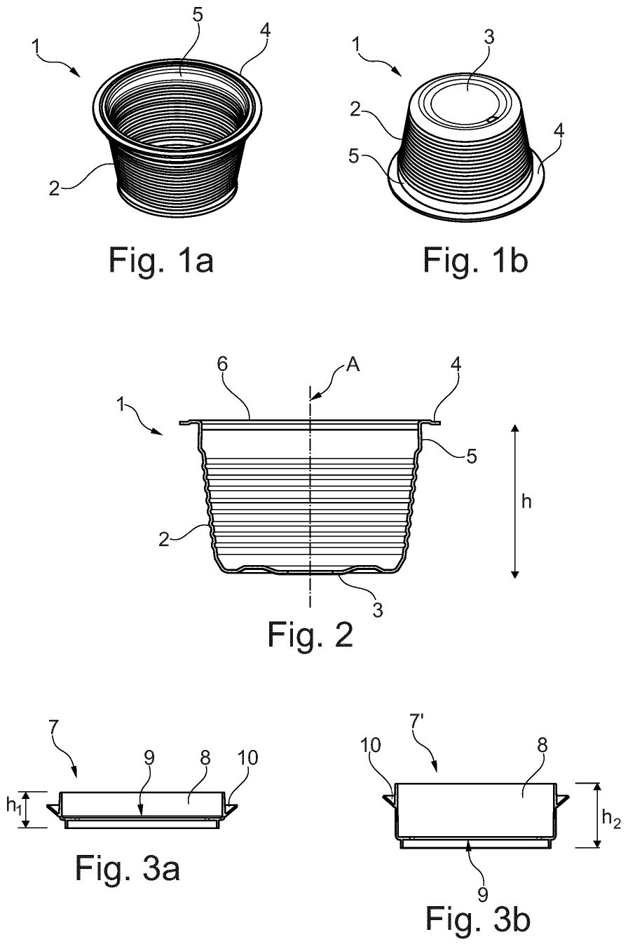

Illustrated in FIGS. 1a and 1b are perspective views of a base element 2 of a single-serve capsule 1, 1′ according to an exemplary embodiment of the present invention. A single-serve capsule 1, 1′of this type is provided to be inserted into a brewing chamber of a beverage preparation machine. In the process, the serve capsule 1, 1′is preferably perforated by corresponding perforation means in a base region 3 and in a cover, in particular a covering film 6, which hermetically closes the opening of the base element 2, and pressurized liquid is directed into the base element 2. The liquid here is preferably cold or hot water. In the process, the water, in particular for preparing coffee beverages, is directed into the single-serve capsule 1, 1′at a pressure of 8 to 12 bar.

Contained in the single-serve capsule 1, 1′is a beverage raw material which interacts with the liquid so as to form a beverage, the latter being subsequently discharged from the single-serve capsule 1, 1′by way of the base region 3.

Beverage preparation machines of this type are well known and will therefore not be described in more detail hereunder.

The base element 2 of the single-serve capsule is preferably designed to be frustoconical and comprises a lateral wall and a base region 3 which is formed integrally with the latter. A cavity which is open on one side is defined by the lateral wall and the base region 3, in which cavity the beverage raw material is disposed, the latter presently and also hereunder not being illustrated for reasons of clarity. Optionally, the single-serve capsule 1, 1′comprises, preferably in the base region 3, a filter element, for example a substantially circular disc of a non-woven and/or felt material, which is sealed in an encircling manner to the base region.

Upon filling the cavity with the beverage raw material, the opening is hermetically closed by a cover, for example a covering film 6. For this purpose, the base element 2 has an encircling flange-type periphery 4 adjacent to the opening, which provides a substantially flat surface to which the covering film 6 is able to be fastened.

The base element 2 is made of a plastics material, for example, in particular deep-drawn from a plastic film. The covering film 6 particularly preferably comprises a multi-layer film, in particular a plastics composite film having at least one barrier layer. The barrier layer can comprise aluminum, for example.

A multiplicity of concentric, encircling and mutually spaced-apart, presently horizontally disposed, grooves or protrusions are presently disposed on the outside of the base element 2. These reinforce the base element, and/or have a merely aesthetic function.

In order to simplify storage of the base elements 2 before or during production of the single-serve capsules 1, 1′, the base element 2, preferably below the flange-type periphery 4, comprises a protrusion in the form of a stacking shoulder 5 in the lateral wall. Base elements 2 which are stacked in one another thus are stored in a form-fitting manner on top of one another by way of the stacking shoulders 5, so that the base regions 3 are mutually spaced apart. As a result, the base elements 2 can be particularly easily unstacked.

Illustrated in FIG. 2 is a lateral cross section of a single-serve capsule 1, 1′according to the exemplary embodiment of the present invention. The embodiment shown here corresponds substantially to the embodiment explained in the context of FIGS. 1a and 1b, so that reference is made to the corresponding explanations.

The horizontal flange-type periphery 4 to which the covering film 6 is fastened, in particular sealed, can be clearly seen in FIG. 2. As can already be seen in FIGS. 1a and 1b, the base element 2 is preferably designed to be rotationally symmetrical, in particular relative to a longitudinal axis A extending centrically through the single-serve capsule 1, 1′, thus vertically in the orientation of the present drawing.

Furthermore, the stacking shoulder 5 below the periphery 4 can be clearly seen. The single-serve capsule 1, 1′ preferably has an axial length, or height h, thus a maximum axial extent parallel to the longitudinal axis A, of approximately 26.6 mm.

For reasons of clarity, no beverage raw material is illustrated in the illustration of FIG. 2; moreover, an insert 7, 7′which is disposed in the single-serve capsule 1, 1′according to the invention, is also absent here.

Illustrated in FIGS. 3a and 3b are schematic cross sections of a first insert 7 and of a second insert 7′ according to an exemplary embodiment of the present invention. It is desirable to be able to prepare different beverages with one beverage preparation system. In particular in the field of coffee beverages, there are furthermore different sub-varieties which in some instances have distinctively different flavors. Two beverages of this type are, for example, an espresso, a comparatively concentrated coffee extract with a comparatively small beverage volume of approximately 25 ml, and a lungo, a coffee extract with a larger beverage volume in comparison to that of an espresso.

Because a brewing chamber of a beverage preparation machine, inter alia for safety reasons—due to the high liquid pressures—has to be adapted to the shape of the single-serve capsule 1, 1′as well as possible, or vice versa, it is desirable to use only single-serve capsules 1, 1′with substantially identical external dimensions, i.e. in particular with substantially identical base elements 2, with one beverage preparation machine.

In order to nevertheless be able to prepare different beverages of high quality, having in particular different quantities of beverage raw material, the internal volume of the cavity of the base element 2 has to be correspondingly variable. Alternatively, it is also known to provide the brewing chamber to be variable in terms of volume, so that single-serve capsules with different external dimensions can also be used.

According to the invention, it is now proposed in order to adapt the internal volume of the base element 2, or in order to adapt the partition of the internal volume of the base element 2, that different inserts 7, 7′are provided. Therefore, at least one first single-serve capsule 1 having a first insert 7, and a second single-serve capsule 1′having a second insert 7, are proposed, wherein the single-serve capsules 1, 1′preferably comprise a substantially identical base element 2, but different inserts 7, 7′.

A first insert 7, as assigned to a first single-serve capsule 1 suitable for preparing a lungo, for example, is now illustrated in FIG. 3a, while a second insert 7′, as is assigned to a second single-serve capsule 1′ suitable for preparing an espresso, in particular, is illustrated in FIG. 3b. The respective base element 2 of the first single-serve capsule 1 and of the second single-serve capsule 1′herein corresponds to the embodiments explained in the context of FIGS. 1a, 1b and 2, for example.

It can be seen immediately that the first insert 7 and the second insert 7′differ substantially in terms of their height h₁, h₂. In particular, both inserts 7, 7′ have an encircling, presently substantially cylindrical, lateral wall 8 having the same diameter, wherein the inserts 7, 7′here have a horizontally disposed base which is preferably formed integrally with the lateral wall 8. This base comprises a multiplicity of openings through which the liquid introduced into the single-serve capsule 1, 1′can pass in order to interact with the beverage raw material. Conversely, the openings are designed in particular in such a manner that the beverage raw material cannot pass through. The base is designed, for example, in the form of a sieve base 9, thus as a substantially planar surface having a multiplicity of openings distributed uniformly across the surface.

A lip-type encircling protrusion 10 which projects obliquely upward is in each case provided externally on the lateral wall 8 here. This protrusion 10 is preferably provided to interact in a form-fitting and/or force-fitting way with the base element 2, as will yet be described in more detail hereunder, in such a manner that the insert 7, 7′is preferably fastened, or disposed, so as to be stationary in the base element 2.

It can be clearly seen in FIGS. 3a and 3b that the protrusion 10 is in each case disposed at a substantially identical spacing from an upper edge of the lateral wall 8. However, the lateral wall 8 of the first insert 7 is substantially shorter than the lateral wall 8 of the second insert 7′. In this way, the sieve base 9 of the second insert 7′is also disposed further below than the sieve base 9 of the first insert 7.

For example, the first insert 7 here has a height h₁, thus a vertical extent parallel to the longitudinal axis A, of approximately 7.17 mm, while the second insert 7′ has a height h₂ of approximately 13.17 mm.

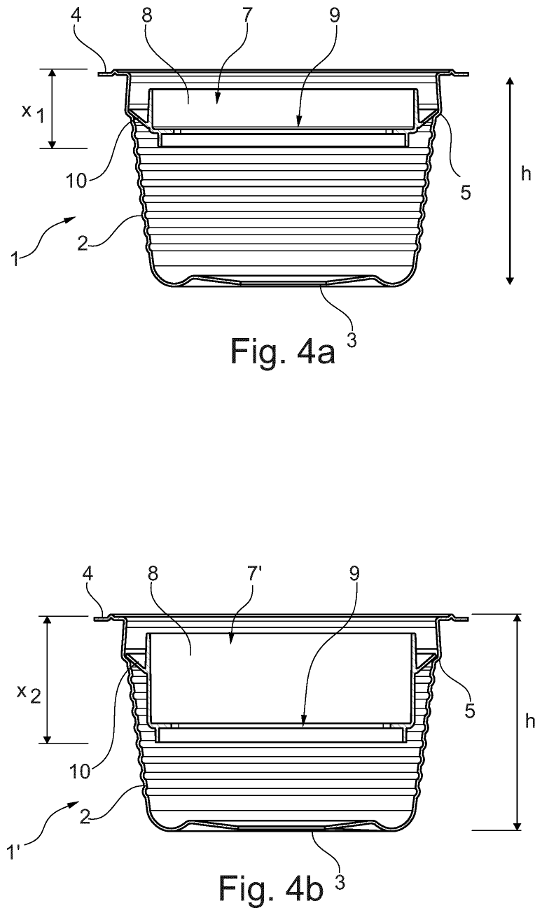

Illustrated in FIG. 4a is a schematic cross section of a first single-serve capsule 1 according to an exemplary embodiment of the present invention. This embodiment corresponds substantially to the embodiments illustrated in FIGS. 1 to 3a, so that reference is made to the corresponding explanations.

In particular, the base element 2 from FIG. 2, having an inserted first insert 7 is illustrated here, so that the illustration shows a first single-serve capsule 1. The first single-serve capsule 1 here is preferably a first type of the single-serve capsule which by way of the first insert 7 is optimized for a specific quantity (i.e. mass) of beverage raw material. By selecting a specific type of beverage raw material and specific quantities, different sub-varieties of first single-serve capsules 1 can also be established. The same applies in an analogous manner to the second single-serve capsule 1′explained in the context of FIG. 4b.

As can be seen in FIG. 4a, the first insert 7 is disposed below the opening in the base element 2. The protrusion 10 herein interacts in a form-fitting way with the stacking shoulder 5 in such a manner that the first insert 7 does not slide further downward into the cavity. Conversely, an upward movement is delimited by a form-fit between the upper edge of the lateral wall 8 and the covering film 6. The first insert 7 thus preferably has some play. Alternatively, the first insert 7 can also be fixedly connected to the base element 2 in a form-fitting, force-fitting and/or materially integral manner; for example, the first insert 7 can be clamped in the base element 2 by way of the protrusion 10.

The first insert 7 now divides the internal volume of the cavity of the base element 2 roughly into two regions, thus two sub-volumes. On the one hand, a first volume which can serve as an accumulation space for the liquid incorporated through the covering film 6 into the single-serve capsules 1 during the preparation, is provided above the first insert 7, thus in particular between the sieve base 9 and the covering film 6. This first volume is also referred to as an effective volume.

Because the first single-serve capsule 1 and the second single-serve capsule 1′preferably have the same diameter and the same height h and the same shape, the effective volume can be characterized, for example, by a first spacing x₁ between the lower edge of the first insert 7 and the covering film. This first spacing x₁ is presently in particular approximately 9.59 mm.

The (maximum) volume available for the beverage raw material thus results in particular from the difference of the internal volume of the cavity (presently approximately 25 ml) and the effective volume. The first single-serve capsule 1 illustrated here is particularly suitable for preparing a lungo with approximately 6.0 g to 6.5 g, or even up to 7.0 g, of coffee powder. The lower volume is particularly preferably not completely filled by the beverage raw material. If the first insert 7, as illustrated here, is disposed with some play in the base element 2, the coffee powder is in particular not compressed by the first insert 7, but there remains a small empty volume in the lower cavity.

The respective insert 7, 7′is preferably adapted to the quantity of the beverage raw material in such a manner that the insert 7, 7′does not compress the beverage raw material but keeps it substantially in position, in particular in such a manner that the beverage raw material cannot move uncontrolled in the single-serve capsule 1, 1′. In this way, a deficient extraction due to a displacement of the beverage raw material can advantageously be precluded.

Illustrated in FIG. 4b is a schematic cross section of a second single-serve capsule 1′according to an exemplary embodiment of the present invention. The above explanations in the context of FIG. 4a apply here in an analogous manner. The second insert 7′here has a greater axial length, thus a greater height h₂, or the second spacing x₂ is greater than the first spacing x₁, respectively. In the embodiment illustrated here the second spacing x₂ is approximately 15.58 mm, for example.

The volume thus remaining free for the beverage raw material in the present case is optimal for a high-quality espresso with a quantity of beverage raw material, thus presently coffee powder, of approximately 5.5 g to approximately 6.0 g.

### LIST OF REFERENCE SIGNS

1, 1′First/second single-serve capsule
2 Base element
3 Base region
4 Periphery
5 Stacking shoulder
6 Covering film
7, 7′First/second insert
8 Lateral wall
9 Sieve base
10 Protrusion
A Longitudinal axis
h Height of the single-serve capsule
h₁ Height of the first insert
h₂ Height of the second insert
X₁ First spacing
X₂ Second spacing

1. A beverage preparation system for preparing a beverage using a single-serve capsule, the system comprising.
a) a beverage preparation machine; and
b) a single-serve capsule;
the beverage preparation machine having a brewing chamber for receiving the single-serve capsule;
the single-serve capsule having:
i) a base element which defines a cavity, the cavity being partially filled with a beverage raw material, and
ii) an insert which is disposed in the cavity and at least partially prevents the beverage raw material from sliding out of position in the cavity;
wherein the beverage preparation system comprises at least one first single-serve capsule and at least one second single-serve capsule, the first single-serve capsule having a first insert, and the second single-serve capsule having a second insert, the first insert being designed dissimilarly to the second insert.
wherein the first and/or the second single-serve capsule comprises a filter element as an additional element; and
wherein an upper edge of the first insert is disposed at a same height relative to the base element as an upper edge of the second insert.

2. The beverage preparation system as claimed in claim 1, wherein the second insert has a greater extent along a longitudinal axis of the single-serve capsule, which corresponds to a rotational symmetry axis, than the first insert.

3. The beverage preparation system as claimed in claim 1, wherein the first insert extends along a longitudinal axis over 20 to 40 percent of an overall extent of the single-serve capsule along the longitudinal axis.

4. The beverage preparation system as claimed in claim 1, wherein the first insert has an extent along a longitudinal axis of 4 to 10 mm.

5. The beverage preparation system as claimed in claim 1, wherein the second insert extends along a longitudinal axis over 40 to 65 percent of an overall extent of the single-serve capsule along the longitudinal axis.

6. The beverage preparation system as claimed in claim 1, wherein the second insert has an extent along a longitudinal axis of 8 to 18 mm.

7. The beverage preparation system as claimed in claim 1, wherein the first insert has a smaller effective volume than the second insert.

8. The beverage preparation system as claimed in claim 1, wherein the first insert effectively occupies 25 to 45 percent of an internal volume of the cavity.

9. The beverage preparation system as claimed in claim 1, wherein the second insert effectively occupies 50 to 65 percent, of an internal volume of the cavity.

10. The beverage preparation system as claimed in claim 1, wherein the first single-serve capsule has a first quantity of beverage raw material, and wherein the second single-serve capsule has a second quantity of beverage raw material, wherein the first quantity is dissimilar to the second quantity.

11. The beverage preparation system as claimed in claim 10, wherein the first quantity is larger than the second quantity.

12. The beverage preparation system as claimed in claim 10, wherein the first quantity comprises 5.5 to 9.5 g.

13. The beverage preparation system as claimed in claim 10, wherein the first quantity effectively occupies 55 to 75 percent of an internal volume of the cavity.

14. The beverage preparation system as claimed in claim 10, wherein the second quantity comprises 4 to 8 g.

15. The beverage preparation system as claimed in claim 10, wherein the second quantity effectively occupies 45 to 50 percent of an internal volume of the cavity.

16. The beverage preparation system as claimed in claim 1, wherein an overall extent along a longitudinal axis, an external volume, and/or an external shape of the first single-serve capsule is identical to the second single-serve capsule, the overall extent being between 20 and 32mm.

17. The beverage preparation system as claimed in claim 1, wherein an internal volume of the cavity is between 20 and 27 ml.

18. The beverage preparation system as claimed in claim 1, wherein an effective volume of the first insert is between 6 and 10 ml.

19. The beverage preparation system as claimed in claim 10, wherein the volume of the first quantity is between 13.5 and 17.5 ml.

20. The beverage preparation system as claimed in claim 1, wherein an effective volume of the second insert is between 8 and 13 ml.

21. The beverage preparation system as claimed in claim 10, wherein a volume of the second quantity is between 10.5 and 15.5 ml.

22. A use of a first single-serve capsule and/or a second single-serve capsule for preparing a beverage in a beverage preparation system as claimed in claim 1.
